(19) United States
(12) Patent Application Publication
(10) Pub. No.: US 2004/0245988 A1
(43) Pub. Date: Dec. 9, 2004

(54) Superconducting planar coil in a low power nuclear quadrupole resonance detection system

(76) Inventor: Daniel B. Laubacher, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/835,346

(22) Filed: Apr. 29, 2004

Related U.S. Application Data
(60) Provisional application No. 60/468,217, filed on May 6, 2003.
(60) Provisional application No. 60/498,314, filed on Aug. 27, 2003.

(51) Int. Cl. G01V 3/00

(52) U.S. Cl. 324/316; 324/300; 324/309

(57) ABSTRACT

The use of a high temperature superconductor self-resonant planar transmit and pickup coil, transmit coil or pickup coil enables the configuration of a small, portable nuclear quadrupole resonance system for detecting contraband.

This application claims the benefit of U.S. Provisional Applications Nos. 60/468,217, filed May 6, 2003; and 60/498,314, filed Aug. 27, 2003; each of which is incorporated in its entirety as a part hereof for all purposes.

### FIELD OF THE INVENTION

This invention relates to the use of a high temperature superconductor (“HTS”) self-resonant planar coil in a low power nuclear quadrupole resonance system for detecting the presence of a particular chemical compound where the compound exhibits a nuclear quadrupole resonance.

### BACKGROUND OF THE INVENTION

The use of nuclear quadrupole resonance (NQR) as a means of detecting controlled substances such as explosives and other contraband has been recognized for some time, see e.g. T. Hirshfield et al, J. Molec. Struct. 58, 63 (1980), A. N. Garroway et al, Proc. SPIE 2092, 318 (1993), and A. N. Garroway et al, IEEE Trans. On Geoscience and Remote Sensing 39, 1108 (2001). NQR provides some distinct advantages over other detection methods. NQR requires no external magnet such as required by nuclear magnetic resonance. NQR is sensitive to the compounds of interest, i.e. there is a specificity of the NQR frequencies.

One technique for measuring NQR in a sample is to place the sample within a solenoid coil that surrounds the sample. The coil provides a radio frequency (RF) magnetic field that excites the quadrupole nuclei in the sample, and results in their producing their characteristic resonance signals. This is the typical apparatus configuration that might be used for scanning mail, baggage or luggage. NQR examination of a sample outside of the detector is also useful, however, as this would permit, for example, passing a wand detector over a container or the human body.

Problems associated with such a detector using conventional systems are the decrease in detectability with distance from the detector coil, and the associated equipment needed to operate the system. As a result, an object of the present invention is to provide a small, low power NQR detector system that is characterized by portability.

### SUMMARY OF THE INVENTION

This invention provides a nuclear quadrupole resonance detection system comprised of a high temperature superconductor self-resonant planar transmit and pickup coil.

This invention also provides a nuclear quadrupole resonance detection system comprised of a high temperature superconductor self-resonant planar transmit coil and a nuclear quadrupole resonance detection system comprised of a high temperature superconductor self-resonant planar pickup coil.

This invention also provides such a nuclear quadrupole resonance detection system contained in a portable system with a hand wand detector. Preferably, the hand wand detector also contains a metal detector.

### DETAILED DESCRIPTION OF THE PREFERRED EMBODIMENTS

This invention provides an NQR detection system that requires low power and therefore can be small in size. It is the use of a high temperature superconductor (HTS) self-resonant planar transmit and pickupcoil, an (HTS) self-resonant planar transmit coil, or an (HTS) self-resonant pickup coil that makes this possible. A pickup coil is alternatively sometimes referred to as a receive coil. The use of an HTS coil greatly reduces the power required. This results in a sufficient reduction in the RF power supply source so that it is small enough to be run on batteries. The system can, therefore, be very small and portable. In particular, the system is small enough to enable the use of a hand wand detector of the type currently used at security check-points to detect metal. Preferably, the hand wand detector would contain both the NQR detector of this invention and a metal detector such as a very low frequency (induction balance) detector, a pulse induction detector, or a beat-frequency oscillator detector.

The use of a HTS self-resonant planar transmit and pickup coil provides several advantages over the conventionally used copper coil. These advantages arise from the high quality factor (“Q”) of the HTS self-resonant coil with a Q on the order of 10³-10⁶ compared to the typical Q of 10² for a copper system. The large Q of the HTS self-resonant coil produces large magnetic field strengths during the RF transmit pulse, and does so at lower RF power levels. This dramatically reduces the amount of transmitted power required to produce NQR signals for detection and thereby reduces the size of the needed RF power supply sufficiently so that it can be run on portable batteries.

The large Q of the HTS self-resonant coil also plays an important role during the receive time. The signal-to-noise (S/N) ratio is proportional to the square root of Q (Q^{1/2}) so that the use of the HTS self-resonant coil results in an increase in S/N by a factor of 10-100 over that of the copper system. These advantages during both the transmit and the receive times enable a detector configuration that is small and portable or movable.

For some applications it may be advantageous to have separate transmit and pickup coils. In these instances one or both of the coils can be HTS self-resonant planar coils. The advantages discussed above for having an HTS self-resonant planar coil during the transmit and the receive times apply to an HTS self-resonant planar transmit coil and an HTS self-resonant planar pickup coil respectively.

It is often advantageous to be able to fine tune the resonance frequency of the pickup coil. One means for accomplishing such tuning is to use two or more coupled high temperature superconductor self-resonant coils. The resonance frequency of the fundamental symmetric mode of the two or more coupled high temperature superconductor self-resonant coils can be varied by mechanically displacing the coils with respect to one another and these coupled coils serve as the HTS pickup coil. Preferably, the two or more coils are planar, i.e., surface, coils. Each planar coil can have an HTS coil configuration on only one side of the substrate, but preferably, has essentially identical HTS coil configurations on both sides of the substrate. Most preferably, each HTS pickup coil is comprised of two or more coupled high temperature superconductor self-resonant planar coils.

The NQR detection system of this invention can be used to detect the presence of chemical compounds for any purpose, but is particularly useful for detecting the presence of controlled substances such as explosives, drugs or contraband of any kind. Such an NQR detection system could be usefully incorporated into a safety system, a security system, or a law enforcement screening system. For example, these systems can be used to scan persons and their clothing, carry-on articles, luggage, cargo, mail and/or vehicles. They can also be used to monitor quality control, to monitor air or water quality, and to detect biological materials.

High temperature superconductors are superconducting above about 77 K, or at temperatures that may be reached by cooling with liquid nitrogen. The planar or surface coil is comprised of a layer of HTS in a coil pattern configuration deposited onto one, or preferably, both sides of a single crystal supporting substrate. The high temperature superconductor used to form the HTS self-resonant coil is preferably selected from the group consisting of YBa₂Cu₃O₇, Tl₂Ba₂CaCu₂O₈, TlBa₂Ca₂Cu₃O₉, (TlPb)Sr₂CaCu₂O₇ and (TlPb)Sr₂Ca₂Cu₃O₉. Most preferably, the high temperature superconductor is Tl₂Ba₂CaCu₂O₈.

The coils could, for example, be constructed from a single crystal sapphire substrate with a CeO₂ buffer layer and a high temperature superconductor centered on said CeO₂ buffer layer on each side of said single crystal sapphire substrate. Or, they could, in a further example, be constructed from a single crystal LaAlO₃ substrate and a high temperature superconductor centered on each side of said single crystal LaAlO₃ substrate.

What is claimed is:

1. A nuclear quadrupole resonance detection system comprised of a high temperature superconductor self-resonant planar transmit and pickup coil.

2. The nuclear quadrupole resonance detection system of claim 1, wherein said system is portable.

3. The nuclear quadrupole resonance detection system of claim 2, wherein said portable system has a hand wand detector.

4. The nuclear quadrupole resonance detection system of claim 3, wherein said hand wand detector also contains a metal detector.

5. A security system, a safety system, or a law enforcement screening system comprising the nuclear quadrupole resonance detection system of any of claims 1-4.

6. A nuclear quadrupole resonance detection system comprised of a high temperature superconductor self-resonant planar transmit coil.

7. A nuclear quadrupole resonance detection system comprised of a high temperature superconductor self-resonant pickup coil.

8. The nuclear quadrupole resonance detection system of claim 7, wherein said pickup coil is a high temperature superconductor self-resonant planar pickup coil.

9. The nuclear quadrupole resonance detection system of claim 7, wherein said pickup coil is comprised of two or more coupled high temperature superconductor self-resonant planar coils.

10. The nuclear quadrupole resonance detection system of any of claims 6-9, wherein said system is portable.

11. The nuclear quadrupole resonance detection system of claim 10, wherein said portable system has a hand wand detector.

12. The nuclear quadrupole resonance detection system of claim 11, wherein said hand wand detector also contains a metal detector.

13. A security system, a safety system, or a law enforcement screening system comprising the nuclear quadrupole resonance detection system of any of claims 6-9.
